(19) United States
(12) Patent Application Publication
(10) Pub. No.: US 2024/0319136 A1
(43) Pub. Date: Sep. 26, 2024

(54) FREE-FLOW ELECTROPHORESIS AND HYDRODYNAMIC FOCUSING

(71) Applicants: Matthew Ryan COURTNEY, Orangeville (CA); Tomasz GLAWDEL, Toronto (CA); Carolyn Liqing REN, Waterloo (CA); Oscar Manuel CARRENO-MOLINA, Maple (CA)

(72) Inventors: Matthew Ryan COURTNEY, Orangeville (CA); Tomasz GLAWDEL, Toronto (CA); Carolyn Liqing REN, Waterloo (CA); Oscar Manuel CARRENO-MOLINA, Maple (CA)

(21) Appl. No.: 18/615,006

(22) Filed: Mar. 25, 2024

Related U.S. Application Data
(60) Provisional application No. 63/492,048, filed on Mar. 24, 2023.

(51) Int. Cl. G01N 27/447; G01N 27/416

(52) U.S. Cl. CPC G01N 27/44769; G01N 27/4167

(57) ABSTRACT

A free-flow electrophoresis apparatus introduces a pressure-driven flow laterally through the sidewalls of a separation chamber. A neutral solute is hydrodynamically focused by the lateral flow before being collected through an outlet at a bottom of the chamber. Meanwhile, charged solutes are removed from the neutral solute stream by application of an electric field. As a result, the neutral solute is both concentrated and isolated from a complex mixture. This purification technique is also versatile, as a pH of the separation medium may be chosen to match a pI of the desired solute.

### CROSS-REFERENCE TO RELATED APPLICATIONS

This application claims the benefit of priority under 35 U.S.C. § 119€ to United States Provisional Patent Application No. 63/492,048, filed Mar. 24, 2023, the disclosure of which is incorporated herein by reference in its entirety.

### FIELD OF THE INVENTION

The present disclosure relates to the separation, purification, and real-time analysis of biological fluid mixtures.

### BACKGROUND

Free-flow electrophoresis (FFE) involves the continuous separation and collection of charged solutes from a containing fluid. The solutes may include proteins, DNA, small molecules, organelles, cells, and particles. At the preparative scale, FFE has been used to purify large quantities of sample (mg/hr). At the analytical scale, FFE has been used in tandem with mass spectrometry or chromatography to analyse complex mixtures. It has also been used to monitor dynamic protein samples in real-time.

A conventional FFE device consists of a thin planar chamber with a height that can range from 0.01 mm to 1 mm. A pressure-driven flow runs through this chamber in the longitudinal direction while an orthogonal electric field is applied in the lateral direction. A sample containing different charged solutes can be injected at the beginning of the chamber. During transit in the longitudinal direction, the charged solutes are deflected laterally due to the electric field. Upon reaching the end of the chamber their total lateral migration distance is determined by their electrophoretic velocity and the pressure-driven flow velocity. Finally, outlets located at the end of the chamber enable collection of the separated solute streams.

Commercial FFE devices were developed in the 1970s for preparative scale applications, and progress continued into the early 2000s. During this time FFE received significant attention, including studies in space to investigate the influence of gravity. Its popularity was due mainly to its potential to purify large quantities of proteins under gentle separation conditions. For example, no harsh solvents or detergents are required, and the separated fractions are already prepared for further analysis. Commercial interest has waned, however, due to a wide range of technical and fundamental issues, and focus has shifted to miniaturized devices that leverage microfluidic technology. These analytical scale devices mainly offer improved heat dissipation and better flow control. Research and development continue today, but no commercial devices exist currently.

The technical issues with respect to commercial FFE devices relate mainly to the electrolysis and Joule heating that occur under high electric fields. These can result in bubbles and pH changes that are detrimental to operation. There are additional concerns due to pressure fluctuations that affect the flow stability over time. Nevertheless, significant efforts have been made to minimize these challenges during the last several decades. The fundamental issues that persist are mainly related to solute dispersion, which can be harmful to both separation resolution and sample throughput.

In conventional free-flow zone electrophoresis (FFZE), two common dispersion sources are molecular diffusion and sample injection width. Another dispersion source is hydrodynamic broadening that arises due to the parabolic velocity profile of the fluid flow. Moreover, electroosmotic flow in the lateral direction produces a pressure-driven backflow, and the parabolic velocity profile thereof leads to an electrodynamic broadening component. Also of concern is electrohydrodynamic broadening if a conductivity gradient exists between the sample and the background electrolyte. Finally, density gradients caused by variations in temperature or sample concentrations may contribute to further broadening when the chamber height is large.

Many advanced separation modes have been introduced to minimize dispersion, including isoelectric focusing, isotachophoresis, field-step electrophoresis, and interval electrophoresis. Free-flow isoelectric focusing (FF-IEF) has had the most success, and it relies on introducing a pH gradient across the separation region. Solutes will migrate to a position along this gradient where their net charge is zero (isoelectric point, pI), and this produces self-sharpening solute distributions that can alleviate many of the dispersion issues mentioned for FFZE.

Despite the potential of FF-IEF, some solutes do not have a well-defined pI, or have poor solubility due to their neutral charge. Furthermore, some proteins approach their pI slowly, which is not ideal for the continuous nature of FFE and can limit the throughput. In addition, the carrier ampholytes required to generate a pH gradient are expensive, and they can bind irreversibly to the separated proteins. The carrier ampholytes can also interfere with the mass spectroscopy signal, which is a common downstream application of FFE. Finally, the strong focusing mechanism can lead to sharp local gradients in concentration, conductivity, and temperature, and as discussed previously this can lead to density gradients.

One solution to the practical limitations of FF-IEF is to continuously recycle the sample back into the chamber. High flow velocities were applied to enable short residence times on the order of seconds rather than minutes to hours. As a result, the sample has less time to be affected by density gradients, and the system can achieve rapid cooling. Proteins gradually reach their pI after several rounds of recycling, thereby avoiding the issue of long focusing times as well. This is a batch mode process, however, rather than a continuous process, therefore limiting throughput. Moreover, there is still a reliance on carrier ampholytes.

Counterflow gradient focusing has been proposed as an alternative to isoelectric focusing. In this method, a bulk fluid velocity is introduced to counteract electrophoretic migration. A gradient exists in one or both of these transport mechanisms, and this allows solutes to focus at unique positions. The focal point is determined by electrophoretic mobility rather than pI, and no carrier ampholytes are required.

Several decades ago, preparative FFE devices employed a counterflow gradient across the chamber by controlling the amount of fluid withdrawn from each outlet. The chamber was divided into compartments separated by porous membranes, and solutes would focus in the compartment where the electrophoretic velocity was approximately equal to the opposing counterflow. Although these devices had several practical limitations, such as membrane fouling, they helped inspire new techniques in capillary electrophoresis. For these devices, an electric field gradient was generated to oppose a constant bulk flow. The gradient could be created by varying the cross-sectional area, conductivity, current density, temperature, and more.

More recently, a new form of free-flow counterflow gradient focusing (FF-CGF) has been introduced. It involves an additional pressure-driven flow through the sidewalls of the chamber. This counterflow is in the same direction as the electric field and uniform along the length of the separation chamber. As the counterflow moves incrementally towards the middle of the chamber, a portion begins to move towards the outlets. Consequently, the fluid flow has a velocity gradient in both the lateral and longitudinal direction. Therefore, as charged solutes migrate laterally due to their electrophoretic velocity, they are opposed by the fluid flow velocity gradient in the lateral direction.

This new FF-CGF method solves many of the practical concerns associated with the previous FFE devices, and has the potential to provide convenient fraction collection at a much higher throughput than the capillary format. Nevertheless, hydrodynamic broadening caused by the parabolic velocity profile of the counterflow remains an issue. As a result, only a small fraction of the solute is focused at the center of the parabola, and the rest is smeared along the chamber walls. Not only does this lead to sample loss, but it also contaminates adjacent solute streams. It is less of a concern when diffusion is the dominant transport mechanism, but this limits the throughput.

There remains, therefore, an ongoing need and desire for further and better solutions which obviate or mitigate one or more disadvantages or shortcomings associated with previous and conventional methods, or which meet or provide for one or more needs or advantages.

### SUMMARY

Free-flow electrophoresis for continuously separating and collecting a concentrated solute from a mixture containing many solutes including a neutral solute and charged solutes. A pressure-driven flow is introduced through sidewalls of a separation chamber in order to hydrodynamically focus the neutral solute, while the charged solutes migrate due to an applied electric field. An outlet positioned at the end of the chamber collects the neutral solute, while adjacent waste outlets collect the charged solutes. The neutral solute is chosen by adjusting a pH of the separation medium to match an isoelectric point of the neutral solute.

Other advantages, features and characteristics of the present invention, as well as methods of operation and functions of the related elements of the structure, and the combination of parts and economies of manufacture, will become more apparent upon consideration of this detailed description with reference to the figures which accompany this application.

### BRIEF DESCRIPTIONS OF THE DRAWINGS

The novel features which are believed to be characteristic of the present invention, and related systems and methods according to the present invention, as to their structure, organization, use and method of operation, together with further objectives and advantages thereof, may be better understood from figures which accompany this application, in which presently preferred embodiments of the invention are illustrated by way of example. However, it is expressly understood that any such figures are for the purpose of illustration and description only and not intended as a definition of the limits of the invention. In the accompanying figures:

FIG. 1 is a schematic diagram of embodiments of an FFE device.

FIGS. 2A and 2B are schematic diagrams respectively illustrating a velocity gradient in both the longitudinal and lateral directions according to some embodiments.

FIG. 3 is a schematic diagram illustrating operation of embodiments of the FFE device including hydrodynamic focusing and collection of a neutral solute and removal of charged solutes through waste ports due to an applied electric field according to some embodiments.

FIG. 4 is a schematic diagram of a parabolic flow profile of a lateral velocity gradient along the height direction according to some embodiments.

FIGS. 5A and 5B are schematic diagrams of, respectively, a solute concentration distribution along a height direction for a neutral solute and several charged solutes, and the corresponding peak distributions according to some embodiments.

FIGS. 6A and 6B are schematic diagrams illustrating an increased resolution when a flow rate through the collection port is restricted according to some embodiments.

FIGS. 7A and 7B are, respectively, an image and chart showing experimental results for a free-flow counterflow gradient focusing of bovine serum albumin at different applied voltages.

FIG. 8 is a flowchart of a method according to some embodiments.

FIGS. 9 & 10 show fluorescent intensity images and related quantification charts of experimental results showing use of a device and method disclosed herein for selective separation of first and second major IgG subclasses from a sample mixture.

It is to be understood that the accompanying drawings are used for illustrating the principles of the embodiments and exemplifications of the invention discussed below. Hence the drawings are illustrated for simplicity and clarity, and not necessarily drawn to scale and are not intended to be limiting in scope. Reference characters/numbers are used to depict the elements of the invention discussed that are also shown in the drawings. The same corresponding reference characters/numbers are given to a corresponding component or components of the same or similar nature, which may be depicted in multiple drawings for clarity. Text may also be included in the drawings to further clarify certain principles or elements of the invention. It should be noted that features depicted by one drawing may be used in conjunction with or within other drawings or substitute features of other drawings. It should further be noted that common and well-understood elements for creating a commercially viable version of the embodiments of the invention discussed below are often not depicted to facilitate a better view of the principles and elements of the invention discussed below.

### DETAILED DESCRIPTION

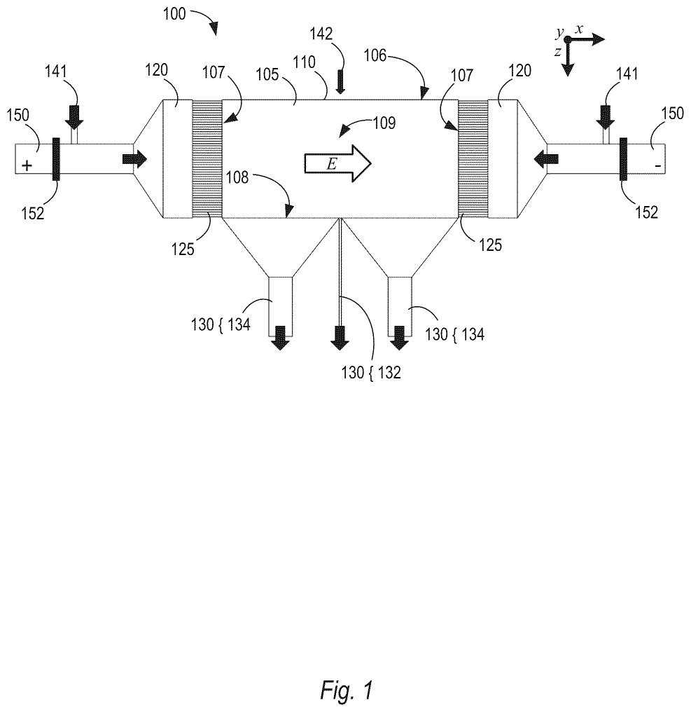

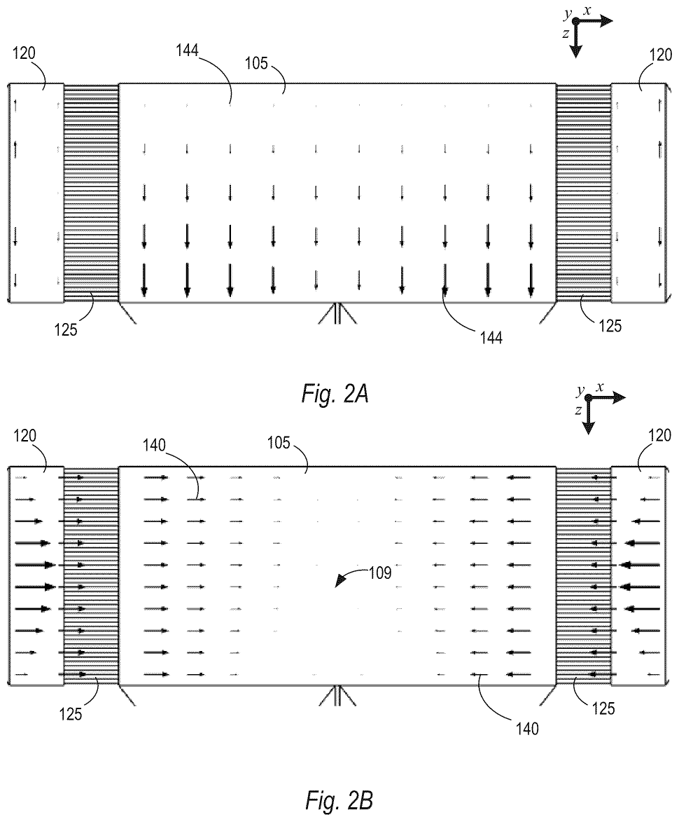

FIG. 1 shows an FFE device 100, which in embodiments is a FF-CGF device, with a separation chamber 105, which in some embodiments is a planar separation chamber. In such case, and as shown in FIG. 1, the separation chamber 105 extends in an xz-plane, and may have any suitable height along the y-axis which is orthogonal to the x-axis and the z-axis. In some embodiments, the height is from about 0.01 mm to about 1 mm. The FFE device 100 has a sample inlet 110 positioned at an inlet end 106 of the separation chamber 105 for sample injection. In some embodiments, the FFE device 100 has additional inlets at the inlet end 106 of the separation chamber 105 to supply an initial flow of buffer solution 144 in a longitudinal direction along the z-axis. The FFE device 100 further has side chambers 120 to supply a lateral flow input of buffer solution in a lateral direction-that is, along the x-axis-from sidewalls 107 of the separation chamber 105, as illustrated by arrows 140 in FIG. 2B. The FFE device 100 further has side chamber inlets 141 to supply fluid into the side chambers 120. In some embodiments, microchannels 125 fluidly couple the side chambers 120 to the separation chamber 105. In some embodiments, the microchannels 125 have a hydrodynamic resistance which is at least a predefined value to promote uniformity of the lateral flow input is uniform along a length of the separation chamber 105 spanning the inlet end 106 and a outlet end 108 of the separation chamber 105 opposite the inlet end 106 along the z-axis. In some embodiments, opposing lateral fluid flows are symmetrical, or equal, with respect to velocity, volume flux, mass flux, or pressure. In other embodiments, opposing lateral fluid flows are asymmetrical, or unequal, with respect to velocity, volume flux, mass flux, or pressure. The FFE device 100 further has one or more outlet ports 130 at the collection end 108 of the separation chamber 105. In some embodiments, the outlet ports 130 include a collection port 132 and one or more waste ports 134. In some embodiments, the FFE device 100 further has outlet microchannels connecting an end of the separation 105 chamber to the outlet ports 130.

The FFE device 100 further has electrodes 150 respectively provided at or adjacent opposite side chambers 120. The electrodes 150 are operable to generate apply an electric field E across the separation chamber 105. In some embodiments, the electrodes 150 are isolated from the buffer solution flowing into the separation chamber from the sidewalls 107. Doing so may tend to prevent unwanted electrolysis effects such as pH changes or air bubbles from entering the separation chamber 105. In some embodiments, an ion exchange membrane or a porous membrane 152 is used to isolate the electrodes 150. In such case, buffer solution on each side of the membrane is continuously replenished or flushed to minimize the effects of electrolysis and ion concentration polarization. In some embodiments, an electrical resistance of the microchannels 125 connecting the side chambers 120 to the separation chamber 105 is preconfigured to limit a voltage drop across the microchannels 125 and maximize a voltage drop across the separation chamber 105 to no more than a predefined value.

The FFE device 100 may be made by any suitable method. In some embodiments, the separation chamber 105, side chambers 120, and microchannels 125 are etched into a base plate, which in some embodiments is glass. The base plate is then bonded to a cover plate, which in some embodiments is glass, to thereby seal the fluidic components. In other embodiments, the FFE device 100 formed from polydimethylsiloxane using standard soft lithography methods. Finally, in some embodiments the FFE device 100 is made from a hard plastic material such as acrylic. In different embodiments, a 3D printer, a laser cutter, or a milling machine are used to create the fluidic components. In different embodiments, pressure sensitive adhesives, gaskets, chemical bonding, or thermal bonding are used to seal the FFE device 100. In some embodiments, surfaces of components of the FFE device 100 are treated with one or more coatings to suppress electroosmotic flow (EOF).

In some embodiments, the FFE device 100 further has or is coupled to one or more pumps to supply fluid flow into the sample inlet 110, or to withdraw fluid flow from the outlet ports 130. When a pressure-driven flow is introduced at the inlet end 106 of the separation chamber 105, the flow moves in the longitudinal direction towards the outlet ports 130 at the outlet end 108 of the separation chamber 105, as illustrated by arrows 144 in FIG. 2A. Meanwhile, another pressure-driven flow is introduced from both side chambers 120, as illustrated by arrows 140 in FIG. 2B. In some embodiments one or more pumps supply pressure-driven fluid flow to the side chambers 120 through the side chamber inlets 141. As these lateral flows 140 move incrementally towards a lateral middle 109 of the separation chamber 105—that is, along the x-axis—a portion will begin moving in the longitudinal direction—that is, along the z-axis—towards the outlet ports 130. Therefore, a fluid flow velocity gradient is created in both the longitudinal and lateral directions, illustrated by the relative sizes of the arrows 140, 144 in FIGS. 2A & 2B.

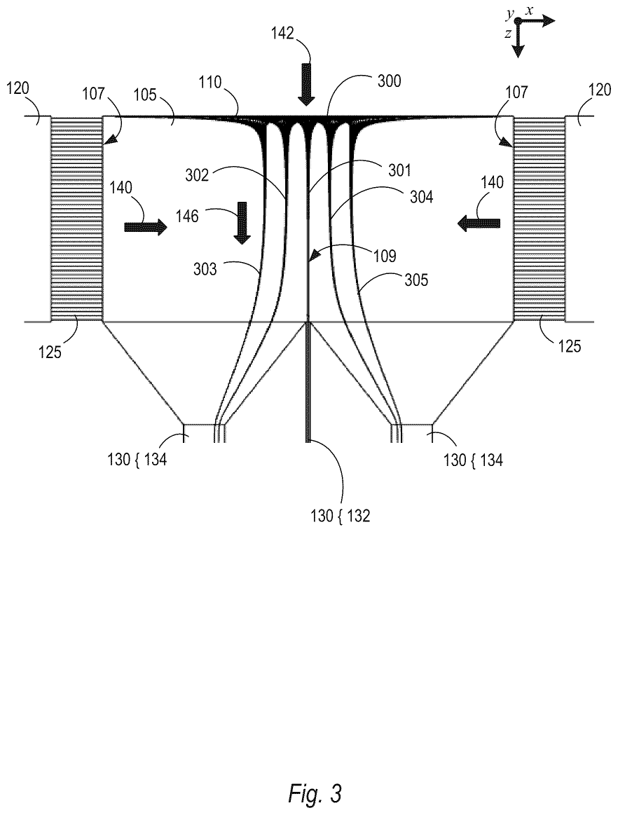

In some embodiments, and as shown in FIG. 3, a sample stream 300 containing different solutes is injected at the sample inlet 110, as illustrated by arrow 142. The sample stream 300 moves in the longitudinal direction towards the outlets 130, as illustrated by arrow 146. The lateral flow from the sidewall 107, illustrated by arrows 140, hydrodynamically focuses the sample stream 300 in the lateral middle 109 of the chamber. A width of the sample stream 300 is determined by a strength of the lateral velocity gradient and a diffusion coefficient of each solute. The focusing mechanism will concentrate the sample stream, but simultaneously dilute it due to the continuous addition of solution from the sidewalls 107. Therefore, the concentration of the sample stream 300 will appear relatively constant until it reaches an equilibrium width. At this point it will be continuously diluted by the side flow. This transition will depend on a number of factors, including the sample flow rate, the lateral velocity gradient, and the residence time.

As described above, an electric field E is then applied in the lateral direction. As a result, charged solutes 302, 303, 304, and 305 move in a direction of the electric field E with an electrophoretic velocity based on an electric field strength of the electric field E and a respective electrophoretic mobility of the charged solutes 302, 303, 304, and 305. (While four charged solutes 302, 303, 304, and 305 are shown in FIG. 3, it will be understood that in different embodiments there are different numbers of charged solutes.) The charged solutes 302, 303, 304, and 305 will then reach a focal point where their respective electrophoretic velocity is counterbalanced by the lateral fluid flow somewhere along the velocity gradient, also known as the counterflow velocity gradient. This is illustrated schematically in FIG. 3 by the relative lateral positions of the charged solute 302, 303, 304, and 305 flows. For each charged solute 302, 303, 304, and 305, the side of the chamber 105 of such focus will depend on whether the corresponding charged solute has a positive or negative charge. Meanwhile, neutral solutes 301 are unaffected by the electric field E, and remain hydrodynamically focused in the middle 109 of the chamber.

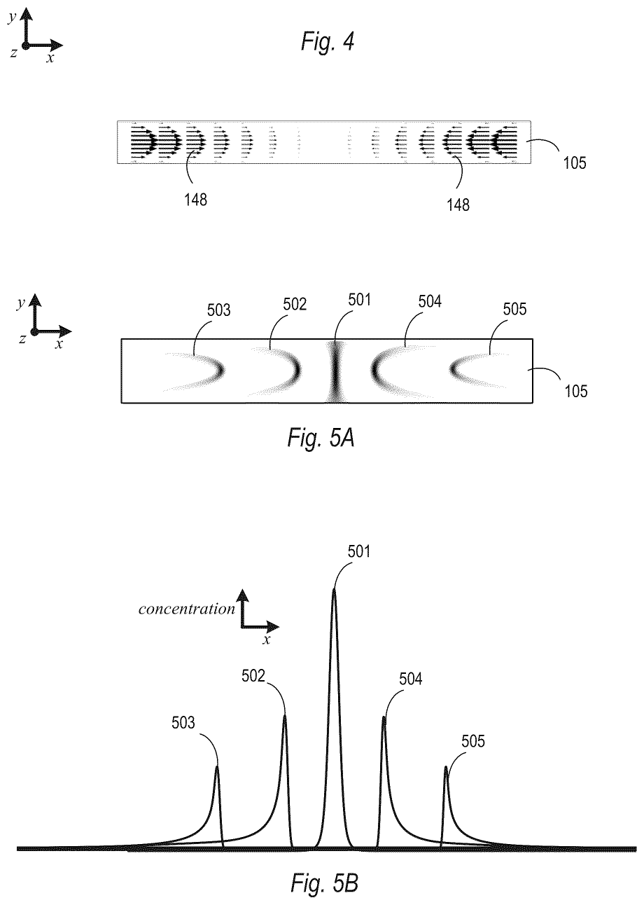

In some embodiments, a height of the separation chamber 105 is such that the pressure-driven flow through the separation chamber involves laminar flow conditions, and therefore the flow is constrained to a parabolic velocity profile along the height direction as illustrated in FIG. 4, in which arrows 148 schematically illustrate a gradient of the lateral flow velocity, along the x-axis, across the height of the separation chamber 105, along the y-axis. The parabolic velocity profile along the height direction causes concentration distributions of the focused solutes to disperse. In some embodiments, when diffusion is the dominant transport mechanism, the distributions will remain relatively Gaussian. If the conditions of operation are selected to maximize both the sample throughput and the focusing mechanism, then in some embodiments convection is the dominant transport mechanism. In this scenario, and as illustrated in FIGS. 5A & 5B, the concentration distribution is materially influenced by the parabolic velocity profile. The charged solutes 502, 503, 504, and 505, corresponding generally to the charged solute 302, 303, 304, and 305 flows, which are each focused at the centre of the corresponding parabola are highly concentrated, but the remaining portion is smeared along the top and bottom chamber walls. In some embodiments, this leads to material sample loss and cross-contamination between adjacent solute streams. Nevertheless, the neutral solute stream 501, corresponding to neutral solute flow 301, is unaffected by the lateral parabolic velocity profile from either side. Moreover, all of the charged solute streams 502, 503, 504, and 505 are smeared away from this neutral stream 501 due to the direction of the parabolic velocity profiles.

Consequently, in some embodiments, when electric field E is applied, the neutral solute stream 301 is substantially concentrated and substantially pure. The disclosed technique is therefore useful for many protein purification applications, as most proteins have an isoelectric point (pI) where their net charge is neutral. If the pH of the buffer solution flowing through the chamber is made to match the pI of the protein of interest, then it can be hydrodynamically focused in the middle of the chamber, while all of the other charged proteins are filtered out. As shown in FIG. 3, a sample outlet 132 positioned at or about the middle 109 of the chamber 105 collects the neutral solute stream 301, while waste outlets 134 located on either side collects the charged solute stream 302,303,304,305.

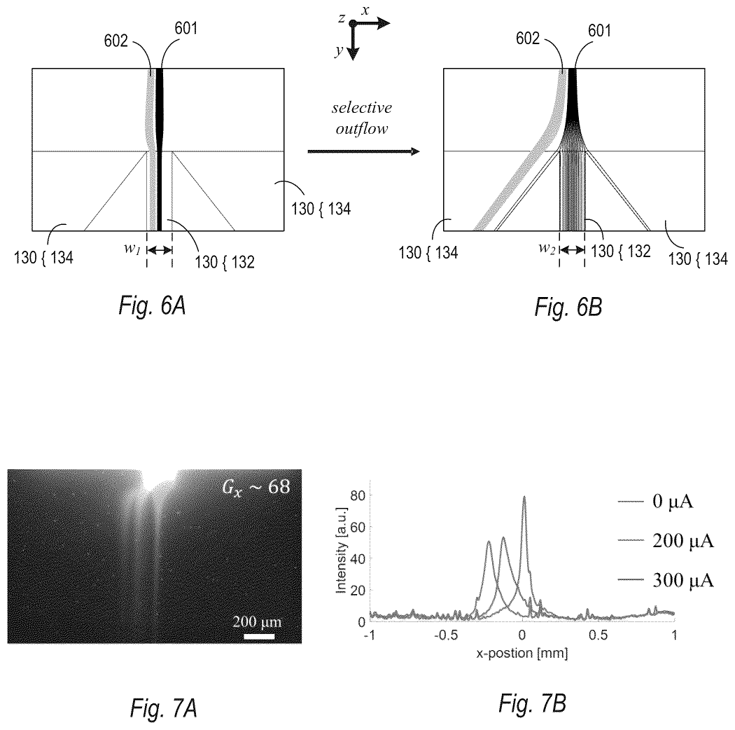

The FFE device 100 components are sized, shaped, and configured in accordance with known requirements, restrictions, and desired outcomes of the operation thereof. In different embodiments, the relative lateral size of openings of the different outlets 130 is selected based on such considerations. For example, a lateral width w of the sample outlet 132 may be selected based on known or expected relative characteristics or properties of the neutral solute and charged solute flows within the separation chamber 105. In different embodiments, such relative outlet widths are selected to control or improve a degree of separation of the neutral solute flow from the charged solute flows. As shown in FIG. 6A, in some embodiments, the sample outlet 132 has a first width w, such that the neutral solute flow 601 and at least some portion of one or more of the charged solute flows 602 passes through the collection port 132. As shown in FIG. 6B, in other embodiments, the sample outlet 132 has a second width w₂ which is less than the first width w₁. In other embodiments, separation of the neutral solute flow from the charged solute flows can instead or additional be performed by limiting a flow rate through the collection port 132 through selective control of a pump, which in some embodiments is a syringe pump, connected to the collection port 132 for operable withdrawal of fluid. In other embodiments, flow rate limiting can be achieved by increasing a hydrodynamic resistance of the collection port 132 channel. In some embodiments, while all of the neutral solute flow 601 passes through the collection port 132, at least some or all of the charged solute flows 602 do not pass through the collection port 132, but instead pass through the waste ports 134. In other embodiments, while at least some of the neutral solute flow 601 passes through the collection port 132, at least some also pass through the waste ports 134 along with the charged solute flows 602. The latter configuration, and the relative amount of neutral solute flow 601 which passes through the waste ports 134, may be selected based on a desired purity of the neutral solute flow 601 which passes through the collection port 132. Such embodiments may be advantageous charged solutes are not optimally separable from the neutral solute based on certain limitations. For example, in some embodiments the electric field strength is limited in order to limit Joule heating, which may result in limitation of the neutral and charged solute flow resolutions when the lateral velocity gradient is above a threshold value. In some embodiments, proteins with a small charge and large size may be particularly difficult to fully separate due to their low mobility, and may therefore contaminate the neutral solute stream going into the collection port. In some embodiments, improvement of the resolving power is achievable by manipulating the fluid dynamics or the electrokinetics.

In other embodiments, yet further techniques are operable for selective and improved separation and purity of the neutral solute flow from the charged solute flows. For example, some embodiments creation of a field-stacking effect in the device, where a conductivity of the buffer is lower in the middle of the chamber than on both sides. In such embodiments, charged solutes near the middle of the chamber move with a higher electrophoretic velocity through the low conductivity region before stacking at the interface of the high conductivity region.

The FFE device 100 is operable to selectively separate and collect multiple different solutes, which in some embodiments are proteins. A pH of the buffer solution flowed through the separate chamber 105 is altered over time and controlled based on the solute to be separated and collected. Solutes, such as proteins, with different pIs sequentially elute through the collection port for neutral solutes. In different embodiments, a continuous pH gradient is provided, a technique common in chromatography systems. In other embodiments, the pH values are discrete and selected beforehand based on the pIs of the solutes, such as proteins, of interest. In some embodiments, a mass spectrometer is coupled directly or indirectly to the collection port for further collection and analysis of these solutes.

In some embodiments, the FFE device 100 is further configured for suppression of electroosmotic flow (EOF) in order to reduce or prevent pressure-driven backflow. In some embodiments, such suppression is performed by providing inner surfaces of the separation chamber 105 with selected coatings operative to perform such suppression. In this way, such embodiments may reduce or prevent electrodynamic broadening of the neutral solute stream by the corresponding parabolic velocity profile, thereby improving or optimizing resolution and purity of the neutral solute flow. In some embodiments, the device 100 may be cooled to counteract Joule heating, in order to reduce or prevent alteration of the buffer solution pH and other parameters by temperature variations.

FIG. 7A shows an image, and FIG. 7B shows a corresponding plot, of a practical implementation of an embodiment of the FF-CGF device made from standard soft lithography techniques. The sample stream contains bovine serum albumin (BSA) labeled with fluorescein isothiocyanate (FITC). It is seen being focused at different applied currents across the separation region, and the corresponding peak measurements are also shown. The parameter Gₓ˜68 is a representation of the hydrodynamic velocity gradient transport relative to the diffusive transport. As shown, the solutes are concentrated when there is no current, similar to what is expected for a neutral solute. When a current is applied, the charged solute migrates away from the middle of the chamber, and the peaks become dispersed as a result of the parabolic velocity profile. The peak overlap illustrated particularly in FIG. 7B provides an indication of what the cross-contamination looks like for adjacent solute streams in some embodiments.

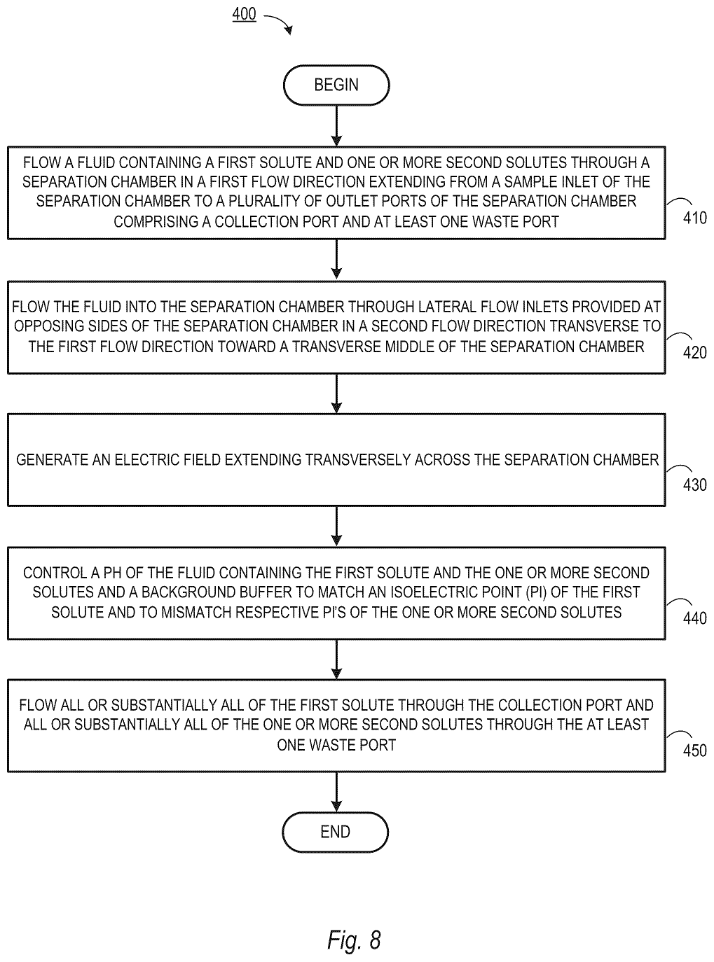

FIG. 8 shows a flowchart of a method 400 for separation of a first solute in a fluid from one or more second solutes in the fluid. In some embodiments, the method is performed using the FFE device 100. A fluid containing the first solute and the one or more second solutes is flowed through a separation chamber in a first flow direction extending from a sample inlet of the separation chamber to a plurality of outlet ports of the separation chamber comprising a collection port and at least one waste port (step 410). The fluid is flowed into the separation chamber through lateral flow inlets provided at opposing sides of the separation chamber in a second flow direction transverse to the first flow direction toward a transverse middle of the separation chamber (step 420). An electric field extending transversely across the separation chamber is generated (step 430). A pH of the fluid containing the first solute and the one or more second solutes and a background buffer is controlled to match an isoelectric point (pI) of the first solute and to mismatch respective pI's of the one or more second solutes (step 440). All or substantially all of the first solute is flowed through the collection port and all or substantially all of the one or more second solutes is flowed through the at least one waste port (step 450).

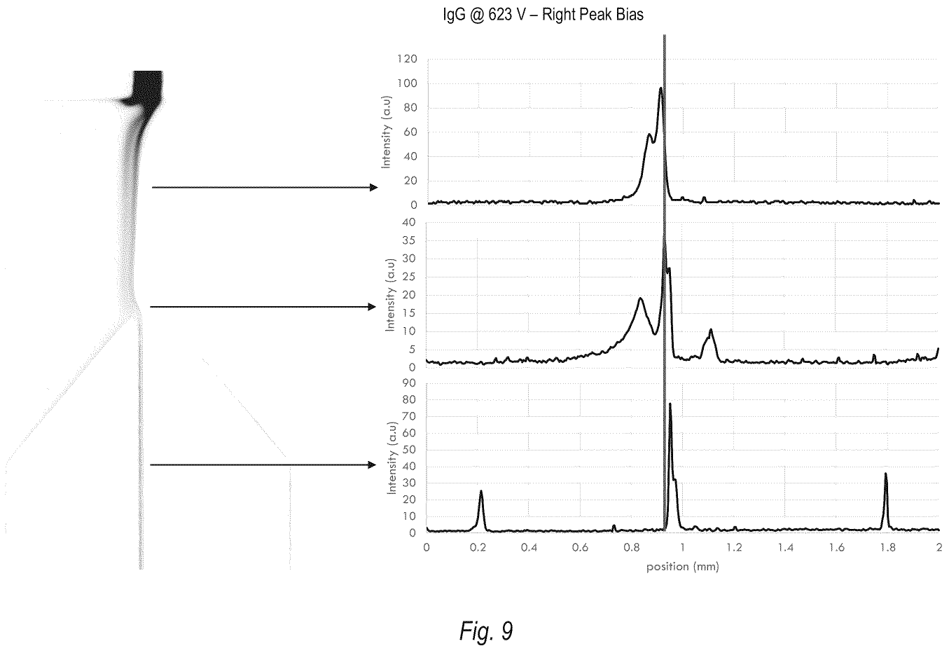

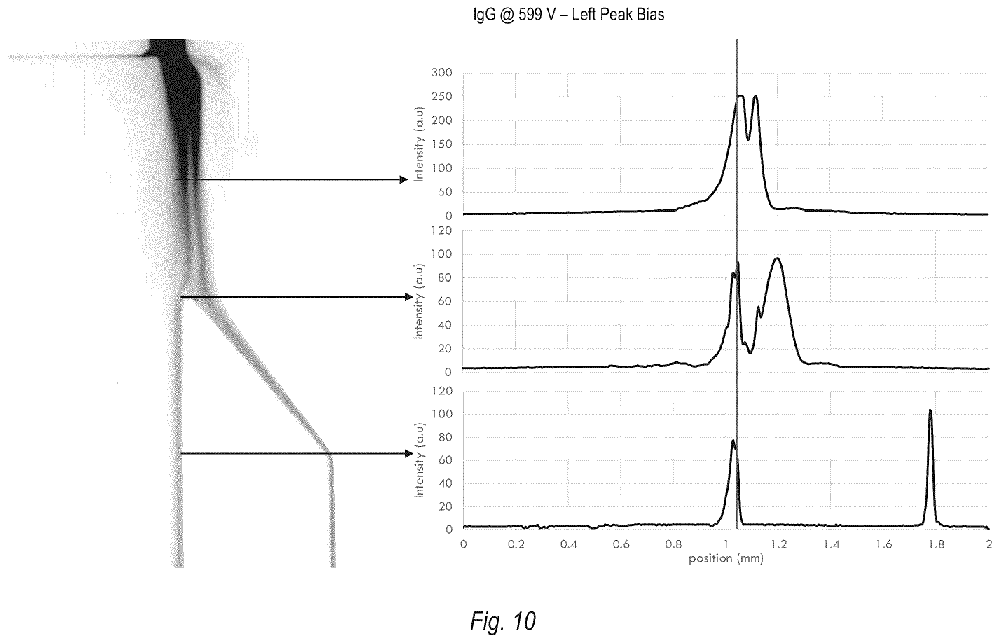

FIGS. 9 and 10 show experimental results of a use of the FFE device 100 and method 400 to selectively separate subclasses of immunoglobulin (IgG) from a sample containing a mixture of IgG subclasses. In particular, the sample mixture was 10 mg/ml IgG-fluorescein isothiocyanate (FITC), with a pI=6.6-7.2. In each of FIGS. 9 & 10, a fluorescence intensity image is shown on the left, and charts presenting quantification at selected stages is shown on the right. In each case, there are two major subclasses of IgG present, as well as several minor subclasses that are less visible. FIG. 9 shows experimental results where the applied electric field E produces a voltage of 623 V across the separation chamber 105, with the result of selectively separating the first major IgG subclass (represented by the right peak) from the sample. FIG. 10 shows experimental results where the applied electric field E produces a voltage of 599 V across the separation chamber 105, with the result of selectively separating the second major IgG subclass (represented by the left peak) from the sample. The results demonstrate the utility of the FFE device 100 and method 400 to selectively separate subclasses of immunoglobulin (IgG) from a sample containing a mixture of IgG subclasses.

Embodiments disclosed herein provide a powerful method for the continuous purification of target solutes, such as proteins. Unlike convention free-flow zone electrophoresis (FFZE), the collected solute stream can be highly focused, and the sample flow rate can be increased significantly without increasing the dispersion. Compared to free-flow isoelectric focusing (FF-IEF), the solute of interest may not be subject to long focusing times, carrier ampholytes may not be needed, and the diluting mechanism may help counteract sharp density gradients that are created due to variations in local temperature, concentration, and conductivity. Compared to previous free-flow counterflow gradient focusing (FF-CGF) methods, the presently-disclosed method may reduce or prevent hydrodynamic dispersion that affects throughput and purity.

Non-limiting embodiments of the present disclosure are as follows.

Embodiment 1. A free-flow electrophoresis device comprising: a separation chamber comprising a sample inlet, and a plurality of outlet ports comprising a collection port and at least one waste port; lateral flow inlets provided at opposing sides of the separation chamber; pumps respectively coupled to the sample inlet and the lateral flow inlets operable to flow fluid containing a first solute and one or more second solutes in a first flow direction extending from the sample inlet to the outlet ports, and to flow the flow fluid from the lateral flow inlets into the separation chamber in a second flow direction transverse to the first flow direction toward a transverse middle of the separation chamber; at least a pair of electrodes respectively disposed at or near the opposing sides of the separation chamber and operable to generate an electric field transversely across the separation chamber.

Embodiment 2. The free-flow electrophoresis device of Embodiment 1 operable to migrate the first solute to or about the transverse center of the separation chamber, and to migrate the one or more second solutes away from the traverse center of the separation chamber, as the first solute and the one or more second solutes are flowed from the sample inlet to the plurality of outlet ports, when a pH of the fluid containing the first solute and the one or more second solutes matches an isoelectric point (pI) of the first solute and mismatches respective pI's of the one or more second solutes.

Embodiment 3. The free-flow electrophoresis device of Embodiment 2 operable to flow all or substantially all of the first solute through the collection port and the flow all or substantially all of the one or more second solutes through the at least one waste port.

Embodiment 4. The free-flow electrophoresis device of any one of Embodiments 1 to 3, configured for suppression of electroosmotic flow (EOF) in order to reduce or prevent pressure-driven backflow of the fluid containing a first solute and one or more second solutes.

Embodiment 5. The free-flow electrophoresis device of Embodiment 4 comprising coatings provided at opposing inner surfaces of the separation chamber operative to suppress the electroosmotic flow.

Embodiment 6. The free-flow electrophoresis device of any one of Embodiments 1 to 5, wherein the collection port and the at least one waste port are configured selectively for separation of the first solute from the and one or more second solutes to a preconfigured degree.

Embodiment 7. The free-flow electrophoresis device of Embodiment 6, wherein a collection port width of the collection port is configured selectively for separation of the first solute from the and one or more second solutes to the preconfigured degree.

Embodiment 8. Use of the free-flow electrophoresis device of any one of Embodiment 1 to 7 to separate the first solute from the one or more second solutes.

Embodiment 9. A method for separation of a first solute in a fluid from one or more second solutes in the fluid, the method comprising: flowing the fluid containing the first solute and the one or more second solutes through a separation chamber in a first flow direction extending from a sample inlet of the separation chamber to a plurality of outlet ports of the separation chamber comprising a collection port and at least one waste port; flowing the fluid into the separation chamber through lateral flow inlets provided at opposing sides of the separation chamber in a second flow direction transverse to the first flow direction toward a transverse middle of the separation chamber; generating an electric field transversely across the separation chamber; controlling a pH of the fluid containing the first solute and the one or more second solutes to match an isoelectric point (pI) of the first solute and to mismatch respective pI's of the one or more second solutes; flowing all or substantially all of the first solute through the collection port and all or substantially all of the one or more second solutes through the at least one waste port.

Embodiment 10. The method of Embodiment 9 comprising providing the free-flow electrophoresis device of any one of Embodiments 1 to 7 and performing the method using the free-flow electrophoresis device.

The foregoing description has been presented for the purpose of illustration and is not intended to be exhaustive or to limit the invention to the precise form disclosed.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

The indefinite articles “a” and “an,” as used herein in the specification and in the claims, unless clearly indicated to the contrary, should be understood to mean “at least one”.

The phrase “and/or”, as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of”, or when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either”, “one of”, “only one of”, or “exactly one of”. “Consisting essentially of”, when used in the claims, shall have its ordinary meaning as used in the field of patent law.

Naturally, in view of the teachings and disclosures herein, persons having ordinary skill in the art may appreciate that alternate designs and/or embodiments of the invention may be possible (e.g., with substitution of one or more components for others, with alternate configurations of components, etc). Although some of the components, relations, configurations, and/or steps according to the invention are not specifically referenced and/or depicted in association with one another, they may be used, and/or adapted for use, in association therewith. All of the aforementioned and various other structures, configurations, relationships, utilities, any which may be depicted and/or based hereon, and the like may be, but are not necessarily, incorporated into and/or achieved by the invention. Any one or more of the aforementioned and/or depicted structures, configurations, relationships, utilities and the 5 like may be implemented in and/or by the invention, on their own, and/or without reference, regard or likewise implementation of any of the other aforementioned structures, configurations, relationships, utilities and the like, in various permutations and combinations, as will be readily apparent to those skilled in the art, without departing from the pith, marrow, and spirit of the disclosed invention.

Other modifications and alterations may be used in the design, manufacture, and/or implementation of other embodiments according to the present invention without departing from the spirit and scope of the invention, which is limited only by the claims of this patent application and any divisional and/or continuation applications stemming from this patent application.

1. A free-flow electrophoresis device comprising:
a separation chamber comprising a sample inlet, and a plurality of outlet ports comprising a collection port and at least one waste port;
lateral flow inlets provided at opposing sides of the separation chamber;
pumps respectively coupled to the sample inlet and the lateral flow inlets operable to flow fluid containing a first solute and one or more second solutes in a first flow direction extending from the sample inlet to the outlet ports, and to flow the flow fluid from the lateral flow inlets into the separation chamber in a second flow direction transverse to the first flow direction toward a transverse middle of the separation chamber; and
at least a pair of electrodes respectively disposed at or near the opposing sides of the separation chamber and operable to generate an electric field transversely across the separation chamber.

2. The free-flow electrophoresis device of claim 1 operable to migrate the first solute to or about the transverse center of the separation chamber, and to migrate the one or more second solutes away from the traverse center of the separation chamber, as the first solute and the one or more second solutes are flowed from the sample inlet to the plurality of outlet ports, when a pH of the fluid containing the first solute and the one or more second solutes matches an isoelectric point (pI) of the first solute and mismatches respective pI's of the one or more second solutes.

3. The free-flow electrophoresis device of claim 2 operable to flow all or substantially all of the first solute through the collection port and the flow all or substantially all of the one or more second solutes through the at least one waste port.

4. The free-flow electrophoresis device of claim 1, configured for suppression of electroosmotic flow (EOF) in order to reduce or prevent pressure-driven backflow of the fluid containing a first solute and one or more second solutes.

5. The free-flow electrophoresis device of claim 4 comprising coatings provided at opposing inner surfaces of the separation chamber operative to suppress the electroosmotic flow.

6. The free-flow electrophoresis device of claim 1, wherein the collection port and the at least one waste port are configured selectively for separation of the first solute from the and one or more second solutes to a preconfigured degree.

7. The free-flow electrophoresis device of claim 6, wherein a collection port width of the collection port is configured selectively for separation of the first solute from the and one or more second solutes to the preconfigured degree.

8. The free-flow electrophoresis device of claim 1, wherein the pumps coupled with the lateral flow inlets provided at the opposing sides of the separation chamber are respectively operable to provide symmetrical lateral fluid flow in the separate chamber.

9. The free-flow electrophoresis device of claim 1, wherein the pumps coupled with the lateral flow inlets provided at the opposing sides of the separation chamber are respectively operable to provide asymmetrical lateral fluid flow in the separate chamber.

10. Use of the free-flow electrophoresis device of claim 1 to separate the first solute from the one or more second solutes.

11. A method for separation of a first solute in a fluid from one or more second solutes in the fluid, the method comprising:
flowing the fluid containing the first solute and the one or more second solutes through a separation chamber in a first flow direction extending from a sample inlet of the separation chamber to a plurality of outlet ports of the separation chamber comprising a collection port and at least one waste port;
flowing the fluid into the separation chamber through lateral flow inlets provided at opposing sides of the separation chamber in a second flow direction transverse to the first flow direction toward a transverse middle of the separation chamber; generating an electric field transversely across the separation chamber;
controlling a pH of the fluid containing the first solute and the one or more second solutes to match an isoelectric point (pI) of the first solute and to mismatch respective pI's of the one or more second solutes; and
flowing all or substantially all of the first solute through the collection port and all or substantially all of the one or more second solutes through the at least one waste port.

12. The method of claim 11 further comprising:
providing a free-flow electrophoresis device comprising:
a separation chamber comprising a sample inlet, and a plurality of outlet ports comprising a collection port and at least one waste port;
lateral flow inlets provided at opposing sides of the separation chamber;
pumps respectively coupled to the sample inlet and the lateral flow inlets operable to flow fluid containing a first solute and one or more second solutes in a first flow direction extending from the sample inlet to the outlet ports, and to flow the flow fluid from the lateral flow inlets into the separation chamber in a second flow direction transverse to the first flow direction toward a transverse middle of the separation chamber; and
at least a pair of electrodes respectively disposed at or near the opposing sides of the separation chamber and operable to generate an electric field transversely across the separation chamber; and
performing the method using the free-flow electrophoresis device.

13. The method of claim 12, comprising flowing the fluid through the lateral flow inlets provided at the opposing sides of the separation chamber so as to provide symmetrical lateral fluid flow in the separate chamber.

14. The method of claim 12, comprising flowing the fluid through the lateral flow inlets provided at the opposing sides of the separation chamber so as to provide asymmetrical lateral fluid flow in the separate chamber.
